(19) United States
(12) Patent Application Publication
(10) Pub. No.: US 2017/0270415 A1
(43) Pub. Date: Sep. 21, 2017

(54) ELECTRONIC DEVICE, SYSTEM, AND METHOD

(71) Applicant: Sony Corporation, Tokyo (JP)

(72) Inventors: Thomas KEMP, Esslingen (DE); Fabien CARDINAUX, Stuttgart (DE); Wilhelm HAGG, Stuttgart (DE); Aurel BORDEWIECK, Kirchheim unter Teck (DE); Stefan UHLICH, Renningen (DE)

(73) Assignee: Sony Corporation, Tokyo (JP)

(21) Appl. No.: 15/447,489

(22) Filed: Mar. 2, 2017

(30) Foreign Application Priority Data
Mar. 15, 2016 (EP) 16160529.0

(51) Int. Cl. G06N 5/04; G06N 99/00

(52) U.S. Cl. CPC G06N 5/04; G06N 99/005

(57) ABSTRACT

An electronic device comprising circuitry configured to: obtain information representing a person's knowledge and/or skills; update a user model representing the person's knowledge and/or skills based on the obtained information; and provide user-adaptive information depending on the user model.

### TECHNICAL FIELD

The present disclosure generally pertains to electronic devices, systems, and methods for a knowledge- and/or skill-adaptive provision of information.

### TECHNICAL BACKGROUND

When browsing or searching the Internet, all users typically get the same data presented in the same fashion. On the one hand, this is a wanted characteristic of a free and open Internet, on the other hand, in particular for those browsing the Internet for e.g. gathering information on a certain topic, a generalized way of providing and representing information can lead to inefficiency as the user's to personal interests, needs, prior knowledge and/or skills are not considered, requiring him/her to identify the desired or suited information themselves.

Thus, it is generally desirable to provide improved electronic devices, systems, and methods for providing user-adaptive information.

### SUMMARY

According to a first aspect, the disclosure provides an electronic device comprising: circuitry configured to: obtain information representing a person's knowledge and/or skills; update a user model representing the person's knowledge and/or skills based on the obtained information; and provide user-adaptive information depending on the user model.

According to a further aspect, the disclosure provides a system comprising: one or more collectors for obtaining information representing a person's knowledge and/or skills; a storage comprising a user model representing the person's knowledge and/or skills based on the obtained information; and an information provider for providing user-adaptive information depending on the user model.

According to a still further aspect, the disclosure provides a method comprising: obtaining information representing a person's knowledge and/or skills; updating a user model representing the person's knowledge and/or skills based on the obtained information; and providing user-adaptive information depending on the user model.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically describes an embodiment of an electronic device that is connected with three companion devices;

FIG. 2 schematically depicts an embodiment of a system for obtaining information representing a person's knowledge and/or skills;

FIG. 3 schematically depicts a further embodiment of a system for obtaining information representing a person's knowledge and/or skills;

FIG. 4 schematically depicts a more detailed view of a PC for obtaining information representing a person's knowledge and/or skills;

FIG. 5 schematically depicts exemplifying sensor data gathered by a heart rate sensor;

FIG. 6 schematically depicts a server and/or cloud platform for obtaining information representing a person's knowledge and/or skills;

FIG. 7 schematically depicts an example of a user model;

FIG. 8 schematically describes a method of obtaining information representing a person's knowledge and/or skills; and

FIG. 9 schematically describes a method of providing user-adaptive information depending on a user model.

### DETAILED DESCRIPTION OF EMBODIMENTS

Considering a user's knowledge and/or skills may significantly increase the effectiveness and value of a personalized recommendation or information provision system.

Accordingly, in the embodiments described below in more detail an electronic device is disclosed comprising circuitry configured to: obtain information representing a person's knowledge and/or skills; update a user model representing the person's knowledge and/or skills based on the obtained information; and provide user-adaptive information depending on the user model.

An electronic device may for example be a PC, or a mobile device such as a mobile phone, a smartphone, a wearable, or the like. Circuitry of the electronic device may comprise processing circuitry such as a processor, or the like.

Information representing knowledge may for example be any piece of information representing theoretic information obtainable by a person, e.g. a person's knowledge about smartphones and their usage.

Information representing skills may for example describe a person's capability to perform a certain practical task of a specific domain, e.g. the task of cooking a specific meal, the task of practicing a specific sport, or the task of playing a specific game. Hence, a skill may be understood as a person's ability to utilize certain information related to a specific domain in practice.

Information representing a person's knowledge and/or skills may be stored in a user model. Such a user model may for example be stored in a database. A user model may comprise information that as a whole or in parts represents a person's knowledge and/or skills in specific domains. A user model may also be denoted as user profile.

The user modelling itself may be user specific. That is the information stored in a user model is typically associated with a single person, e.g. the user of an electronic device. A user model may not only represent knowledge and/or skills. It may also represent a person's interests.

In an electronic device of the embodiments, obtaining information representing a person's knowledge and/or skills may comprise determining a domain of knowledge and/or skills.

A domain of knowledge and/or skills could e.g. be “Mountainbiking” (skill) or “Electrical Engineering” (knowledge).

Collectors may be capable of automatically determining a domain by e.g. using a camera, etc. For example a collector may use images captured by a camera and image matching technologies to determine that a user is cooking, or that a user is playing tennis. Alternatively a domain may be determined on a central server or in a cloud platform, e.g. based on the data representing a person's knowledge and/or skills.

A domain may also be inseparably linked to a collector (e.g. smart tennis racket or car).

A domain may further include a number of sub-domains. For example the domain “Mountainbiking” may comprise the sub-domains “Uphill”, “Downhill”, or the like.

In an electronic device of the embodiments, the circuitry may be configured to obtain the information representing a person's information gathering and skills from one or more data collectors. A collector may for example be used to monitor a person's information gathering and skills in practice. For example, a data collector may monitor a person's information gathering.

A data collector may be a device or system which is equipped with sensors or means to gather information used to feed and improve the user's knowledge and skill model. Examples arc a computer, a smartphone, a car or a tennis racket with integrated acceleration sensors etc. or a combination of such devices. A collector may also comprise a computer used to browse the Internet with an agent that monitors a person's usage of the computer. A collector may also be software that is arranged to collect data.

An exemplifying usage of the electronic device relates to a person's gathering of information via RSS newsfeeds. If a person maintains multiple RSS subscriptions, repeated coverage of a certain topic may lead to a high redundancy in information provision. In such a case, an electronic device may hide pieces of information the person presumably already knows. This may result in an increased efficiency of the person's information gathering.

In an electronic device of the embodiments, a data collector may obtain information representing the level of the person's attention during information gathering. To this end, a data collector may for example comprise means for monitoring eye-movements, means for monitoring the time when information is gathered, and/or means for monitoring body parameters such as the person's heart rate, or the like.

In an electronic device of the embodiments, a data collector may comprise one or more sensors which provide information on a person's domain-specific skills. A data collector may for example comprise one or more cameras, accelerometers, in sports gears etc.

For example, a collector may be a smart tennis racket which is equipped with acceleration and/or position sensors. A smart tennis racket may collect sensor data during a person's usage of the tennis racket, and may transmit the collected data to an electronic device, central server or cloud platform using for example the user's smartphone as a gateway. Such a smart tennis racket may be used to obtain information representing a person's knowledge and/or skills in the domain “Tennis”. The domain “Tennis” may contain subdomains such as “Acceleration” or “Impact Hardness”. The smart tennis racket may continuously measure the acceleration values of the specific player and may transmit them to a backend such as an electronic device, a central server or a cloud platform, e.g. by using the smartphone as a gateway. The backend may determine that the acceleration/impact hardness is very low for a male player of the given age. Therefore the skill assessed to the domain “Tennis”—sub-domain “Acceleration” could be “Novice”. The backend may now provide/recommend or highlight information which may make the user recognize this improvement potential once the user uses the smart tennis racket the next time.

In an electronic device according to an embodiment, a data collector may obtain information representing a person's information gathering and skills based on: displayed information content itself; how demanding displayed information is; the amount of time a person spends on gathering information; and/or the time at which the gathering of information occurred.

Analyzing the displayed/viewed information content may for example comprise a semantic analysis of the content. Determining how demanding information is may for example comprise analyzing the terminology and/or vocabulary of the content.

Determining the amount of time a person spends on gathering the information may for example comprise determining if a person spent one hour per day or per week on gathering information of a specific domain. The more time a person spends on gathering information of a specific domain, the higher will normally be the knowledge of the person about this specific domain.

Determining the time at which the gathering occurred may for example comprise determining if the gathering of information occurred yesterday or one year ago. The longer a person's gathering of information in a specific domain is ago, the lower will normally be the knowledge of the person about this specific domain. If, for example, a user model indicates that a person last dealt with the domain “Electrical Engineering” twenty years ago, then the person may be attributed the status “Not up-to-date” in this specific domain, despite that the knowledge of the person in this specific domain once was rather high.

An example of (theoretic) knowledge may be the domain “Smartphones”, sub-domain “XPhone 12”, sub-domain “Battery Runtime”. A collector may continuously monitor the user when gathering information on the Internet or offline (e.g. using a camera). Based on a semantic analysis and means such as Face and eye tracking, or by just measuring the time the user spends reading a certain news article etc., it may be determined what the user presumably knows about the “XPhone 12”. An example could be that the user has read two articles about this new “XPhone 12”. Both these articles stated that the battery lasts for 1.5 days.

In an electronic device of the embodiments, the circuitry may be configured to provide user-adaptive information by means of one or more information providers.

An information provider may be a device or system used by the user to gather information and/or to improve his skills in a certain domain or gather knowledge. An example would be a computer used to browse the Internet, an Internet browser, or the like.

Data collectors and providers may run a certain software used to extract and transmit the relevant data or to adapt presented information according the user model on the frontend side, e.g. on a PC, or on a smartphone. Such software may be provided in form of a computer program, or service running in the background on a computer, a plugin that is installed within an Internet browser, or a software agent.

Providing user-adaptive information may operate with all types of media such as text, video or audio.

If, for example, a user model indicates that the user is considered to be an expert in the “XPhone 12”, subdomain “Battery runtime”, when the user opens a new article about the “XPhone 12” and this new article also contains the information about the battery lifetime, the user's PC, mobile phone or Internet browser may automatically be configured to hide this part of the text. Vice versa it may highlight text parts which presumably are new to the user.

Both information gathering and provision may occur in the same device, for example on a PC which is equipped with an Internet browser.

In an electronic device of the embodiments, providing user-adaptive information depending on a user model may comprise selecting, displaying, re-arranging, highlighting, recommending, or hiding information depending on the user model. Providing user-adaptive information may for example comprise directly jumping to certain time marks in video or audio content or automatically creating video/audio or text summaries/podcasts containing information with respect to the underlying user model.

In order to personalize the providing of user-adaptive information, the available content may be analyzed. For example, a software agent or browser plugin may automatically search the content and try to determine if it is matching one of the existing domains. If this is the case, the system may modify the content before and/or while it is shown to the user. Alternatively the software agent or browser plugin may automatically provide content or recommendations to the user, which can improve the user's knowledge or skill in a certain domain.

Providing user-adaptive information may also comprise highlighting or hiding text or reducing its visibility.

Accordingly, the electronic device may provide information to people with respect to their presumed knowledge and/or skills. More precisely, the electronic device may increase the efficiency and pleasure of a user's information provision and gathering by avoiding redundancy and demanding too much or too little from a person.

For example, the electronic device may allow to monitor user activities in greater detail and to enhance the performance and scope of a recommendation or adaptive content/information provision system.

In an electronic device of the embodiments, the user model may comprise information that is specific to a certain domain of knowledge and/or skill. For example, pieces of data included in the user model may be attributed to a specific domain of knowledge and/or skill.

In an electronic device of the embodiments, the user model may consider both, the aggregation and loosing of information. Loosing information may for example relate to a person forgetting knowledge after longer periods of not making use of the knowledge.

In an electronic device of the embodiments, the circuitry may further be configured to identify a user. A means for identifying a user may be any type of sensor capable of determining unique body characteristics (fingerprint/heartbeat/voice/face etc.), typically a fingerprint sensor, a camera, and/or a microphone, or the like.

User identification may happen both, with respect to data provision and/or with respect to data collection. This may allow to attribute collected data to a specific person in order to build user models, and this may allow to personalize the provision of user-adaptive information for a specific person.

In an electronic device of the embodiments, the circuitry may be configured to communicate with a centralized server and/or with a cloud platform, the centralized server and/or cloud platform maintaining the user model.

In an electronic device of the embodiments, the circuitry may be configured to provide a user with a skill/knowledge assessment based on the obtained information representing the user's knowledge and/or skills.

For example, the system may determine a certain domain or sub-domain-specific skill or knowledge value based on the data provided by the data collectors.

For each domain and eventual sub-domain certain skill parameters may be defined. An example of a skill parameter may relate to a person's capabilities of accelerating a tennis racket. Such a skill parameter may for example be “Newbie”, “Novice”, “Beginner”, “Skilled”, “Intermediate”, “Experienced”, “Advanced”, “Senior”, “Expert”, or the like. In addition or alternatively, a skill/knowledge assessment may be represented by a number that represents a person's knowledge and/or skill.

Data collectors may be equipped with means allowing them to derive skill parameters. In addition or alternatively, a central server or a cloud platform may be configured to derive skill parameters. Data collectors may further be equipped with means allowing them to transmit collected sensor data, skill parameters or values to a central server and/or to a cloud platform.

In addition or alternatively, a central server and/or a cloud platform may be equipped with means allowing them to determine skill parameters based on sensor data obtained by data collectors.

The circuitry of the electronic device may be configured to receive skill parameters from such a central server and/or cloud platform.

Based on the measurements a system may assess a skill for the domain or sub-domain.

In the embodiments described below in more detail it is also disclosed a system comprising: one or more collectors for obtaining information representing a person's knowledge and/or skills; a storage comprising a user model representing the person's knowledge and/or skills based on the obtained information; and an information provider for providing user-adaptive information depending on the user model.

A collector of the system may be any of the collectors described above.

A storage may be any means that is configured to store information, such as a data storage device (hard disk, SSD, or the like) or data memory (SDRAM, or the like).

An information provider may comprise circuitry, e.g. a processor located in an electronic device, in a central server or in a cloud platform. An information provider may for example be a PC, an Internet browser, a software agent, or the like.

In addition or alternatively, an information provider may comprise an output device (e.g. a display, touch screen, loud speaker, or the like) that is configured to present information to a user. The output device may for example be located in an electronic device such as a PC, smartphone, or wearable.

The system may further comprise a centralized server and/or a cloud platform. The centralized server and/or the cloud platform may comprise a storage comprising a user model. Accordingly, the user modelling may be done on a centralized server and/or within a cloud platform.

The centralized server and/or the cloud system maintaining the user model may collect in Formation From the data collectors, or it may collect information From aggregator hubs related to data collectors, using e.g. an Internet or local network connection.

The embodiments also disclose a system capable of automatically identifying a user, assessing his skills and/or knowledge in a specific domain and adapting the representation of information with respect to the knowledge and/or skills assessment therefore achieving a higher degree of personalization.

The proposed system may represent a holistic approach for a smarter recommendation and information provision system which may actually ease people's lives and pointedly improves theirs knowledge and/or skills.

In the embodiments described below in more detail it is also disclosed a method comprising: obtaining information representing a person's knowledge and/or skills; updating a user model representing the person's knowledge and/or skills based on the obtained information; and providing user-adaptive information depending on the user model. A method according to the embodiments may perform any of the processes described above with regard to the described electronic device and system.

The methods may be computer-implemented methods. Thus the embodiments also disclose computer programs for performing the processes disclosed in this specification.

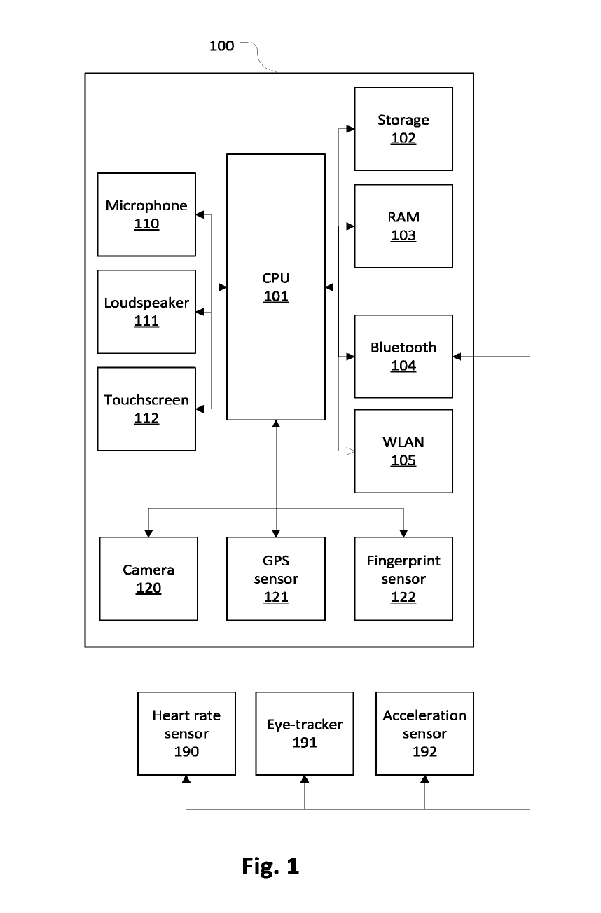

FIG. 1 schematically describes an embodiment of an electronic device that is connected with three companion devices. The electronic device 100 comprises a CPU 101 as processor. The electronic device 100 further comprises a microphone 110, a loudspeaker 111, and a touchscreen 112 that are connected to the processor 101. These units 110, 111, 112 act as a man-machine interface and enable a dialogue between a user and the electronic device. The electronic device 100 further comprises a Bluetooth interface 104 and a WLAN interface 105. These units 104, 105 act as I/O interfaces for data communication with external devices such as companion devices, servers, or cloud platforms. The electronic device 100 further comprises a camera sensor 120, a GPS sensor 121 and a fingerprint sensor 122. These units 120, 121, 122 act as data sources and provide sensor data. The fingerprint sensor 122 may be used to identify the user of the electronic device 100. The electronic device 100 is connected to three companion devices, namely a heart rate sensor 190, an eye-tracker 191, and an acceleration sensor 192 via the Bluetooth interface 104. These units 190, 191, 192 also act as data sources and provide sensor data to electronic device 100. The electronic device 100 further comprises a data storage 102 and a data memory 103 (here a RAM). The data memory 103 is arranged to temporarily store or cache data or computer instructions for processing by processor 101. The data storage 102 is arranged as a long term storage, e.g. for recording sensor data obtained from the data sources 120, 121, 122, 190, 191, 192.

It should be noted that the description above is only an example configuration. Alternative configurations may be implemented with additional or other sensors, storage devices, interfaces or the like. It should also be noted that microphone 110 which is listed above as unit attributed to the man machine-interface can likewise act as a source for sensor data. For example, microphone 110 may capture ambient sound that may allow processor 101 to recognize that the user of the electronic device is playing tennis, is cooking, etc.

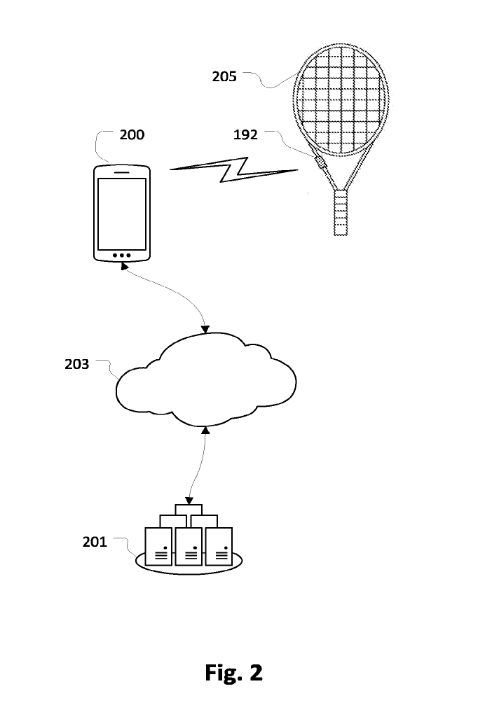

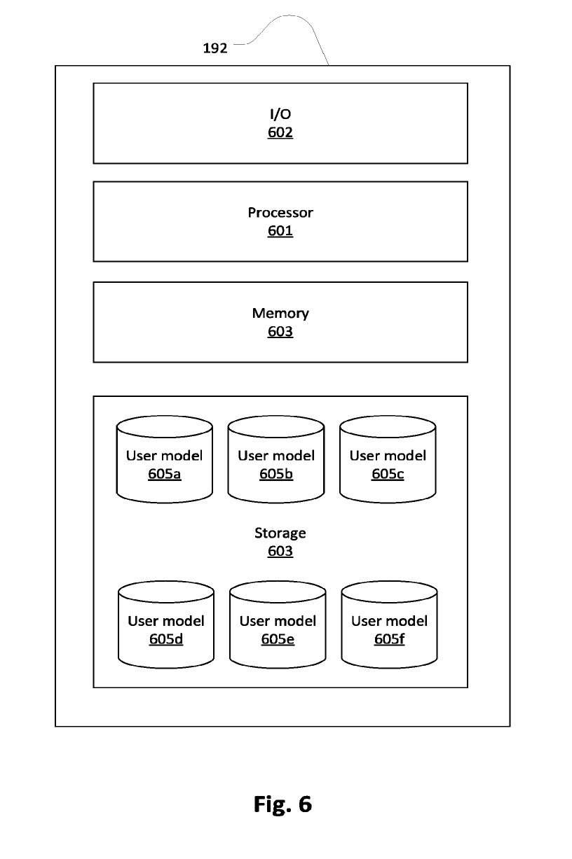

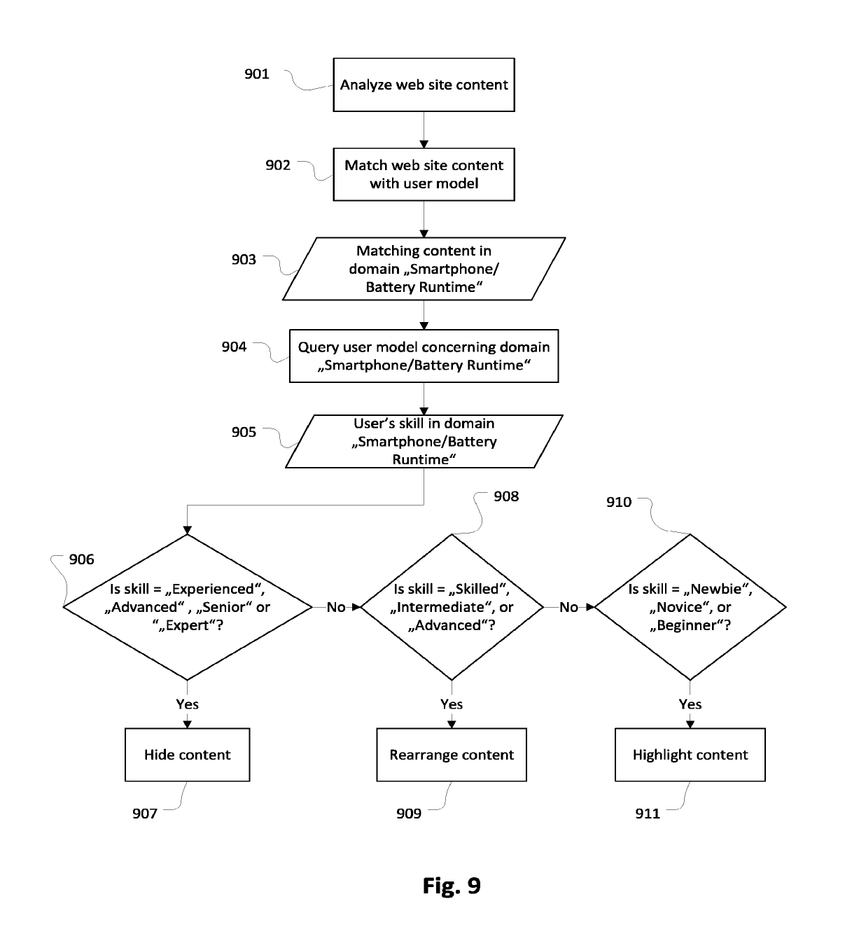

FIG. 2 schematically depicts an embodiment of a system for obtaining information representing a person's knowledge and/or skills. The system comprises a smartphone 200. This smartphone 200 is an example of an electronic device as described in FIG. 1. Smartphone 200 communicates with a smart tennis racket 205. The smart tennis racket 205 comprises an acceleration sensor 192 attached to a racket, the acceleration sensor 192 also comprises a Bluetooth interface for wireless communication with smartphone 200. The acceleration sensor 192, by collecting information about the usage of the smart tennis racket 205, acts as collector for obtaining information representing a person's skills in playing tennis. For example, acceleration sensor 192 may provide information about the user's skill in accelerating a tennis racket, or information about the impact hardness the user can achieve. The data collected by acceleration sensor 192 is wirelessly transferred to smartphone 200. Smartphone 200 collects the data transmitted by acceleration sensor 192 and transfers this data, via a local LAN and/or the Internet 203, to a server or cloud platform 201 where the collected data is used to update a user model (see 605a-f in FIG. 6) representing the user's knowledge and/or skills based on the obtained information. Still further, smartphonc 200 can act as an information provider for providing user-adaptive information depending on the user model stored in the server or cloud platform 201 (see e.g. flow chart of FIG. 9).

It should be noted that a wireless connection between the smart tennis racket 205 and the smartphone 200 must not necessarily always exist. For example, the acceleration sensor 192 may collect data for certain periods of time and later transfer this information to smartphone 200 when a wireless (or, alternatively an USB) connection is established between the acceleration sensor 192 and smartphone 200. Still further it is noted that even though in the embodiment of FIG. 2 a smartphone 200 is used as gateway for transmitting the data collected by smart tennis racket 205 to the server or cloud platform 201, in still other embodiments the data collected by smart tennis racket 205 respectively its acceleration sensor 192 may be directly transmitted to the server or cloud platform 201, e.g. by using an UMTS/LTE interface, or the like.

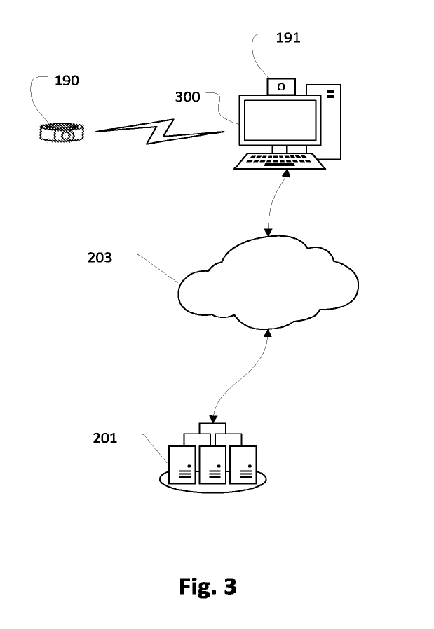

FIG. 3 schematically depicts a further embodiment of a system for obtaining information representing a person's knowledge and/or skills. The system comprises a PC 300. This PC 300 is an example of an electronic device as described in FIG. 1. PC 300 communicates with an eye-tracker 191 installed on PC 300 and with a heart rate sensor 190. Eye-tracker 191 is connected to PC 300 via an USB interface. Heart rate sensor 190 is connected to PC 300 via a wireless Bluetooth connection. The eye-tracker 191, by collecting information about the user of PC 300, acts as collector for obtaining information representing the user's knowledge and/or skills. For example, information obtained from the eye-tracker 191 can be used to identify which pieces of information presented on PC 300 (e.g. by means of a web browser, or the like) are actually consumed by the user of PC 300. Still further, eye-tracker 191 may provide information about the user's stress level and thus may indicate how familiar the user is with the consumed content, and thus may provide information about the user's knowledge in the domain of the consumed content. Likewise, the heart rate sensor 190, by collecting information about its bearer, acts as collector for obtaining information representing the user's knowledge and/or skills. For example, information obtained from the heart rate sensor 190 may provide information about the user's stress level and thus may indicate how familiar the user is with consumed content that is presented on PC 300. Still further, heart rate sensor 190 may provide information about how fit a person is when performing sports or when performing walking, hiking, cycling, or the like. Thus heart rate sensor 190 may provide information about the user's knowledge and/or skills in certain domains. PC 300 collects the data transmitted by eye-tracker 191 and heart rate sensor 190 and transfers this data, via a local LAN and/or the Internet 203 to a server or cloud platform 201 where the collected data is used to update a user model (see 605a-f in FIG. 6) representing the person's knowledge and/or skills based on the obtained information. PC 300 can also act as an infotiiiation provider for providing user-adaptive information depending on the user model stored in the server or cloud platform 201 (see e.g. filtering plugin 406 as described with regard to

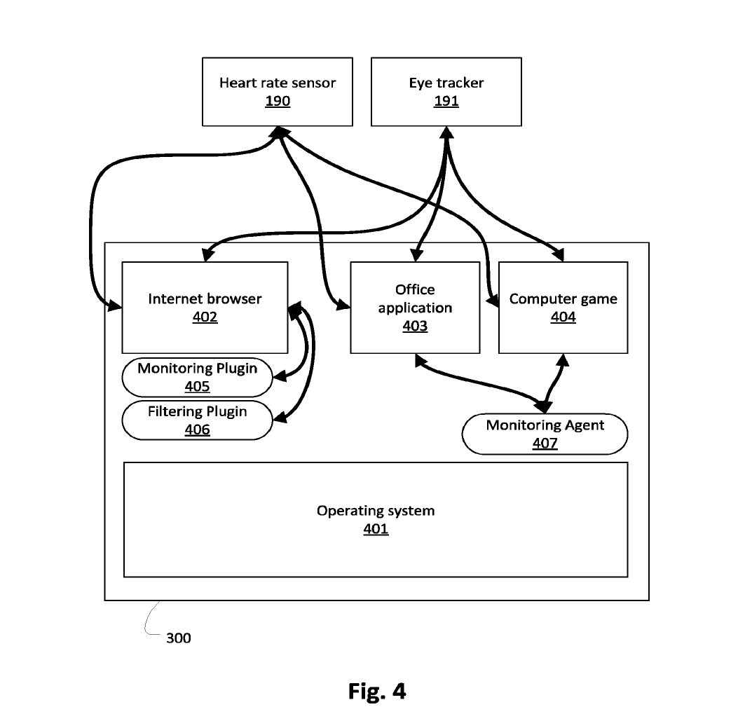

FIG. 4 below, and sec flow chart of FIG. 9).

It should be noted that a wireless connection between the heart rate sensor 190 and PC 300 must not necessarily always exist. For example, the heart rate sensor 190 may collect data for certain periods of time and later transfer this information to PC 300 when a wireless (or, alternatively an USB) connection is established between the heart rate sensor 190 and PC 300. Still further it is noted that even though in the embodiment of FIG. 3 a PC 300 is used as gateway for transmitting the data collected by heart rate sensor 190 and eye-tracker 191 to server or cloud platform 201, in still other embodiments, the data collected by heart rate sensor 190 and eye-tracker 191 may be directly transmitted to the server or cloud platform 201, e.g. by using an UMTS/LTE interface, or the like.

FIG. 4 schematically depicts a more detailed view of a PC For obtaining information representing a person's knowledge and/or skills. The PC 300 comprises an operating system 401 that runs applications such as an Internet browser 402, an office application 403 and a computer game 404. As indicated by the black arrow, a monitoring plugin 405 of the Internet browser 402 is configured to monitor the usage of the Internet browser 402. For example, the monitoring plugin 405 may monitor the information content displayed by Internet browser 402. Also, the monitoring plugin 405 can monitor the amount of time a user spends on gathering information; and/or the time at which the gathering of information occurs. Further, a filtering plugin 406 of the Internet browser 402 is configured to select, display, re-arrange, highlight, recommend, or hide information depending on a user model. Still further, as indicated by the black arrows, a monitoring agent 407 installed on the operating system 402 is configured to monitor the usage of applications, for example usage of the office application 403 and usage of the computer game 404. For example, the monitoring agent 407 may monitor the information content managed by office application 403, or how the user is acting in computer game 404. Also, the monitoring agent 407 can monitor the amount of time a user spends on working with the office application 403 and playing computer game 404; and/or the time at which this occurs. Still further, the monitoring agent 407 is configured to select, display, rearrange, highlight, recommend, or hide information of applications running on operating system 401 depending on a user model.

Still further, as indicated by the black arrows, a heart rate sensor 190 and an eye-tracker 191 are communicatively coupled with PC 300 in order to gather information about the user's usage of Internet browser 402, office application 403 and computer game 404.

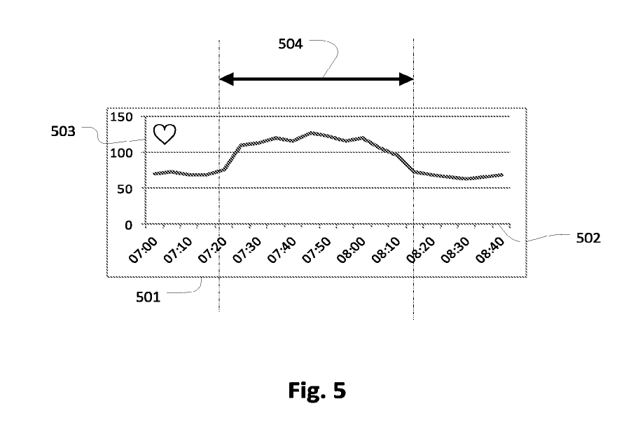

FIG. 5 schematically depicts exemplifying sensor data gathered by a heart rate sensor. The sensor data is plotted in a diagram 501. On the horizontal axis 502 the diagram displays the time of collection of the sensor data. On the vertical axis 503 the diagram displays the heart rate at the respective time of collection of the sensor data. As demonstrated in FIG. 5, during the time interval 504 the heart rate is increased. This may reflect that the user wearing the heart rate sensor is performing sport during time interval 504. If, for example, it is known from other information sources that the user is cycling to work during this time interval 504, and, it is known e.g. from a

GPS sensor, how fast the user is cycling to work, the system may deduce from diagram 501 how skilled (here: trained) the user is in the domain of cycling.

FIG. 6 schematically depicts a server and/or cloud platform for obtaining information representing a person's knowledge and/or skills. The server/cloud platform 201 comprises an I/O interface 602, e.g. a network interface, for enabling communication with electronic devices such as a smartphone (200 in FIG. 2) or a PC (300 in FIG. 3). The server/cloud platform 201 further comprises a processor 601 for executing computer programs. For example, the computer-implemented methods described in this specification may be performed either by this processor 601, or by this processor 601 in cooperation with a processor located in an electronic device (such as smartphone 200 of FIG. 2 or PC 300 of FIG. 3). The server/cloud platform 201 further comprises a memory 603, e.g. a RAM, for temporarily storing data such as program code or user data received from the I/O interface 602. The server/cloud platform 201 further comprises a storage 601, e.g. one or more hard disks or solid state disks for storing data. The storage 601 stores multiple user models 605a-f, each user model being associated with an individual user.

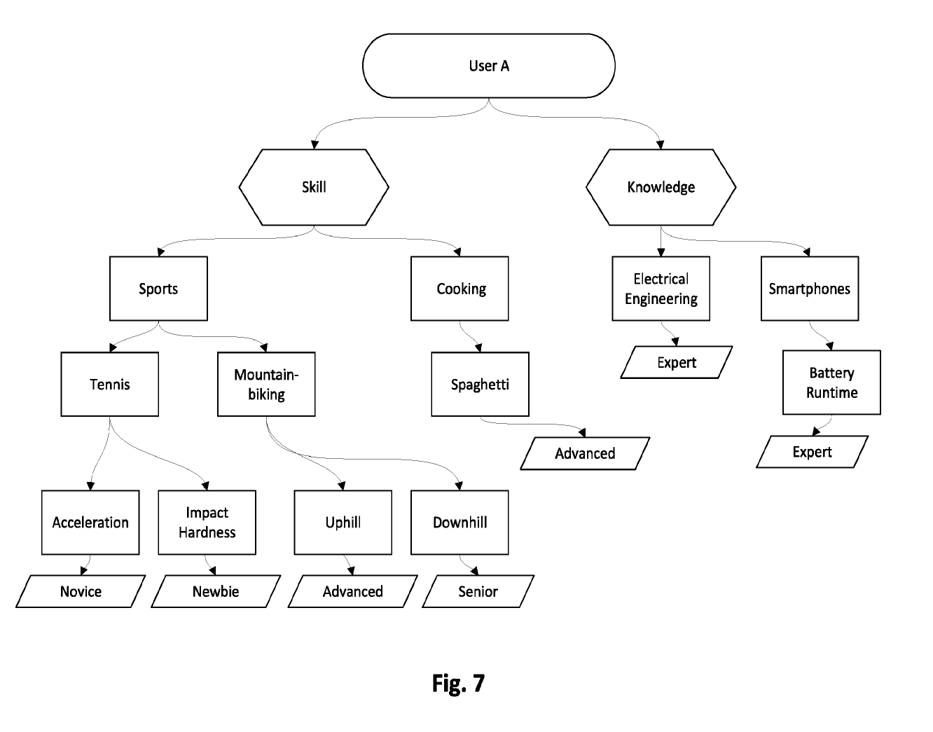

FIG. 7 schematically depicts an example of a user model. The user model is attributed to a “User A” and may for example be stored in a server and/or cloud platform such as described with regard to FIG. 6. According to the user model of FIG. 7 skills and knowledge in specific domains are attributed parameters such as “Newbie”, “Novice”, “Beginner”, “intermediate”, “Skilled”, “Experienced”, “Advanced”, “Senior”, and “Expert”. These parameters of the user model quantize how skilled/knowledgeable a person is in a respective domain.

The user model is generally separated into the sections “Skill” and “Knowledge”. The section “Skill” comprises information describing a person's capability to perform certain practical tasks of a specific domain, the section “Knowledge” comprises information representing theoretic information obtainable by a person.

In the example given here, the section “skill” comprises two domains, namely “Sports” and “Cooking”. The domain “Sports” comprises two subdomains, namely “Tennis” and “Mountainbiking”. The subdomain “Tennis” comprises two further subdomains, namely “Acceleration” and “Impact Hardness”. According to the user model, in the domain “Sports/Tennis/Acceleration” “User A” is attributed the skill “Novice”. Further, according to the user model, in the domain

“Sports/Tennis/Impact Hardness” “User A” is attributed the skill “Newbie”. The subdomain “Mountainbiking” of domain “Sports” comprises two further subdomains, namely “Uphill” and “Downhill”. According to the user model, in the domain “Sports/Mountainbiking/ Uphill” “User A” is attributed the skill “Advanced”. Further, according to the user model, in the domain “Sports/Mountainbiking/Downhill” “User A” is attributed the skill “Senior”. Further, the domain

“Cooking” comprises one subdomain, namely “Spaghetti”. According to the user model, in the domain “Cooking/Spaghetti” “User A” is attributed the skill “Advanced”.

Still further, in the example given here, the section “Knowledge” comprises two domains, namely “Electrical Engineering” and “Smartphones”. According to the user model, in the domain “Electrical Engineering” “User A” is considered as an “Expert”. The domain “Smartphones” comprises one subdomain, namely “Battery Runtime”. According to the user model, in the domain “Smartphones/Battery Runtime” “User A” is considered as an “Expert”.

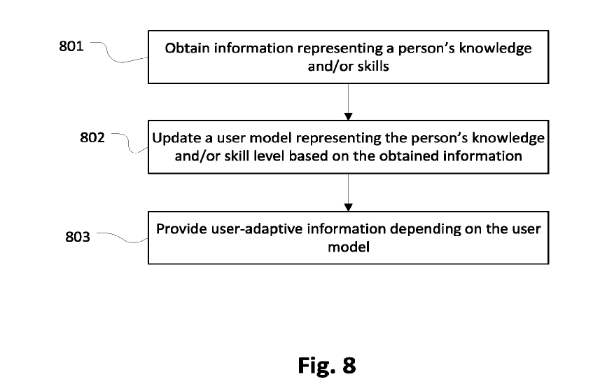

FIG. 8 schematically describes a method of obtaining information representing a person's knowledge and/or skills. At 801, information representing a person's knowledge and/or skills is obtained. At 802, a user model representing the person's knowledge and/or skills is updated based on the obtained information. At 803, user-adaptive information is provided depending on the user model.

FIG. 9 schematically describes a method of providing user-adaptive information depending on a user model. At 901, web site content (e.g. retrieved by monitoring plugin 405 of FIG. 4) is analyzed (e.g. by processor 601 of FIG. 6). At 902, the web site content is matched with a user model (e.g. a user model such a described with regard to FIG. 7). The result of this matching is a matching content 903, here in the domain “Smartphone/Battery Runtime”. At 904, the user model is queried concerning the domain of matching content 903. As a result, the user's skill 905 in the domain “Smartphone/Battery Runtime” is obtained. At 906, it is checked if the user's skill 905 in the domain “Smartphone/Battery Runtime” is one of “Experienced”, “Advanced”, “Senior”, or “Expert”. If yes, the process proceeds at 907. At 907, the matching content 903 is hidden (e.g. by filtering plugin 406 or monitoring agent 407 of FIG. 4). If no, the process proceeds at 908. At 908, it is checked if the user's skill 905 in the domain “Smartphone/Battery Runtime” is one of “Skilled” or “Intermediate”. If yes, the process proceeds at 909. At 909, the matching content 903 is rearranged (e.g. by filtering plugin 406 or monitoring agent 407 of FIG. 4). If no, the process proceeds at 910. At 910, it is checked if the user's skill 905 in the domain “Smartphone/Battery Runtime” is one of “Newbie”, “Novice,” or “Beginner”. If yes, the process proceeds at 911. At 911, the matching content 903 is highlighted (e.g. by filtering plugin 406 or monitoring agent 407 of FIG. 4).

It should be recognized that the embodiments describe methods with an exemplary ordering of method steps. The specific ordering of method steps is however given for illustrative purposes only and should not be construed as binding. For example the ordering of the checks 906, 908 and 910 in the embodiment of FIG. 9 may be exchanged. Other changes of the ordering of method steps are apparent to the skilled person.

Further, it should be recognized that the division of the electronic device 100 of FIG. 1 into units 101 to 122 is only made for illustration purposes and that the present disclosure is not limited to any specific division of functions in specific units. For instance, processor 101, touch screen 112, and other components may be implemented by a respective programmed processor, field programmable gate array (FPGA), software and the like. The same applies for the functionalities that are presented in the embodiment of FIG. 2.

Further, it should be recognized that as far as the disclosure refers to circuitry that is configured to perform a specific function it is also envisaged that the circuitry may be configured to perform this specific function by means of computing instructions, software, computer programs, and/or the like.

Methods for controlling an electronic device, such as electronic device 10, are discussed above.

These methods can also be implemented as a computer program causing a computer and/or a processor (such as processor 101 in FIG. 1 and/or processor 601 in FIG. 6 discussed above), to perform the methods, when being carried out on the processor.

In some embodiments also a non-transitory computer-readable recording medium is provided that stores therein a computer program product, which, when executed by a processor, such as the processor described above, causes the method described to be performed.

All units and entities described in this specification and claimed in the appended claims can, if not stated otherwise, be implemented as integrated circuit logic, for example on a chip, and functionality provided by such units and entities can, if not stated otherwise, be implemented by software.

In so far, as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An electronic device comprising circuitry configured to:

obtain information representing a person's knowledge and/or skills; update a user model representing the person's knowledge and/or skills based on the obtained information; and provide user-adaptive information depending on the user model.

(2) The electronic device of (1), wherein obtaining information representing a person's knowledge and/or skills comprises determining a domain of knowledge and/or skill.

(3) The electronic device of (1) or (2), wherein the circuitry is configured to obtain the information representing a person's information gathering and skills from one or more data collectors.

(4) The electronic device of (3), wherein a data collector obtains information representing the level of the person's attention during information gathering.

(5) The electronic device of (3) or (4), wherein a data collector comprises one or more sensors which provide information on a person's domain-specific skills.

(6) The electronic device of anyone of (3) to (5), wherein a data collector obtains information representing a person's information gathering and skills based on:
displayed information content itself;
how demanding displayed information is;
the amount of time a person spends on gathering information; and/or
the time at which the gathering of information occurred.

(7) The electronic device of anyone of (1) to (6), wherein the circuitry is configured to provide user-adaptive information by means of one or more information providers.

(8) The electronic device of anyone of (1) to (7), wherein providing user-adaptive information depending on the user model comprises selecting, displaying, re-arranging, highlighting, recommending, or hiding information depending on the user model.

(9) Electronic device of anyone of (1) to (8), wherein the user model comprises information that is specific to a certain domain of knowledge and/or skill.

(10) The electronic device of anyone of (1) to (9), wherein the user model considers both, the aggregation and loosing of information.

(11) The electronic device of anyone of (1) to (10), wherein the circuitry is further configured to identify a user.

(12) The electronic device of anyone of (1) to (11) wherein the circuitry is configured to communicate with a centralized server and/or with a cloud platform, the centralized server and/or the cloud platform maintaining the user model.

(13) The electronic device of anyone of (1) to (12), wherein the circuitry is configured to provide a user with a skill/knowledge assessment based on the obtained information representing the user's knowledge and/or skills.

(14) A system comprising:
one or more collectors for obtaining information representing a person's knowledge and/or skills;
a storage comprising a user model representing the person's knowledge and/or skills based on the obtained information; and
an information provider for providing user-adaptive information depending on the user model.

(15) A method comprising:
obtaining, by processing circuitry, information representing a person's knowledge and/or skills;
updating, by processing circuitry, a user model representing the person's knowledge and/or skills based on the obtained information; and
providing, by processing circuitry, user-adaptive information depending on the user model.

(16) A computer program comprising program code causing a computer to perform the method of (15), when being carried out on a processor.

(17) A non-transitory computer-readable recording medium that stores therein a computer program product, which, when executed by a processor, causes the method of (15) to be performed.

The present application claims priority to European Patent Application 16160529.0 filed by the European Patent Office on 15 März 2016, the entire contents of which being incorporated herein by reference.

1. An electronic device comprising circuitry configured to:
obtain information representing a person's knowledge and/or skills;
update a user model representing the person's knowledge and/or skills based on the obtained information; and
provide user-adaptive information depending on the user model.

2. The electronic device of claim 1, wherein obtaining information representing a person's knowledge and/or skills comprises determining a domain of knowledge and/or skill.

3. The electronic device of claim 1, wherein the circuitry is configured to obtain the information representing a person's information gathering and skills from one or more data collectors.

4. The electronic device of claim 3, wherein a data collector obtains information representing the level of the person's attention during information gathering.

5. The electronic device of claim 3, wherein a data collector comprises one or more sensors which provide information on a person's domain-specific skills.

6. The electronic device of claim 3, wherein a data collector obtains information representing a person's information gathering and skills based on:
displayed information content itself;
how demanding displayed information is;
the amount of time a person spends on gathering information; and/or
the time at which the gathering of information occurred.

7. The electronic device of claim 1, wherein the circuitry is configured to provide user-adaptive information by means of one or more information providers.

8. The electronic device of claim 1, wherein providing user-adaptive information depending on the user model comprises selecting, displaying, re-arranging, highlighting, recommending, or hiding information depending on the user model.

9. Electronic device of claim 1, wherein the user model comprises information that is specific to a certain domain of knowledge and/or skill.

10. The electronic device of claim 1, wherein the user model considers both, the aggregation and loosing of information.

11. The electronic device of claim 1, wherein the circuitry is further configured to identify a user.

12. The electronic device of claim 1 wherein the circuitry is configured to communicate with a centralized server and/or with a cloud platform, the centralized server and/or the cloud platform maintaining the user model.

13. The electronic device of claim 1, wherein the circuitry is configured to provide a user with a skill/knowledge assessment based on the obtained information representing the user's knowledge and/or skills.

14. A system comprising:
one or more collectors for obtaining information representing a person's knowledge and/or skills;
a storage comprising a user model representing the person's knowledge and/or skills based on the obtained information; and
an information provider for providing user-adaptive information depending on the user model.

15. A method comprising:
obtaining, by processing circuitry, information representing a person's knowledge and/or skills;
updating, by processing circuitry, a user model representing the person's knowledge and/or skills based on the obtained information; and
providing, by processing circuitry, user-adaptive information depending on the user model.
